(19) United States
(12) Patent Application Publication
(10) Pub. No.: US 2019/0279083 A1
(43) Pub. Date: Sep. 12, 2019

(54) Computing Device for Fast Weighted Sum Calculation in Neural Networks

(71) Applicant: DINOPLUSAI HOLDINGS LIMITED, Fremont, CA (US)

(72) Inventors: Cliff Gold, Fremont, CA (US); Tong Wu, Fremont, CA (US); Yujie Hu, Fremont, CA (US); Chung Kuang Chin, Saratoga, CA (US); Xiaosong Wang, Fremont, CA (US); Yick Kei Wong, Union City, CA (US)

(21) Appl. No.: 15/956,988

(22) Filed: Apr. 19, 2018

Related U.S. Application Data
(60) Provisional application No. 62/639,451, filed on Mar. 6, 2018.

(51) Int. Cl. G06N 3/08; G06F 7/544; G06N 3/063

(52) U.S. Cl. CPC G06N 3/08; G06N 3/04; G06N 3/063; G06F 7/5443

(57) ABSTRACT

A computing device for fast weighted sum calculation in neural networks is disclosed. The computing device comprises an array of processing elements configured to accept an input array. Each processing element comprises a plurality of multipliers and a multiple levels of accumulators. A set of weights associated with the inputs and a target output are provided to a target processing element to compute the weighted sum for the target output. The device according to the present invention reduces the computation time from M clock cycles to log₂M, where M is the size of the input array.

### CROSS REFERENCE TO RELATED APPLICATIONS

The present invention claims priority to U.S. Provisional Patent Application, Ser. No. 62/639,451, filed on Mar. 6, 2018. The U.S. Provisional Patent Application is hereby incorporated by reference in its entirety.

### FIELD OF THE INVENTION

The present invention relates to a computing device to support operations required in neural networks. In particular, the present invention relates to hardware architecture that achieves many folds of speed improvement over the conventional hardware structure.

### BACKGROUND

Today, artificial intelligence has been used in various applications such as perceptive recognition (visual or speech), expert systems, natural language processing, intelligent robots, digital assistants, etc. Artificial intelligence is expected to have various capabilities including creativity, problem solving, recognition, classification, learning, induction, deduction, language processing, planning, and knowledge. Neural network is a computational model that is inspired by the way biological neural networks in the human brain process information. Neural network has become a powerful tool for machine learning, in particular deep learning, in recent years. In light of power of neural networks, various dedicated hardware and software for implementing neural networks have been developed.

FIG. 1A illustrates an example of a simple neural network model with three layers, named as input layer 110, hidden layer 120 and output layer 130, of interconnected neurons. The output of each neuron is a function of the weighted sum of its inputs. A vector of values (X₁ . . . X_{M}) is applied as input to each neuron in the input layer. Each input in the input layer may contribute a value to each of the neurons in the hidden layer with a weighting factor or weight (Wᵢⱼ). The resulting weighted values are summed together to form a weighted sum, which is used as an input to a transferor activation function, ƒ(·) for a corresponding neuron in the hidden layer. Accordingly, the weighted sum, Yⱼ for each neuron in the hidden lay can be represented as:

Yⱼ=Σᵢ₌₁³WᵢⱼXᵢ, (1)

where Wᵢⱼ is the weight associated with Xᵢ and Yⱼ. The output, yᵢ at the hidden layer becomes:

yⱼ=ƒ(Σᵢ₌₁³WᵢⱼXᵢ+b), (2)

where b is the bias.

The output values can be calculated similarly by using yⱼ as input. Again, there is a weight associated with each contribution from yⱼ. FIG. 1B illustrates an example of a simple neural network model with four layers, named as input layer 140, layer 1 (150), layer 2 (160) and output layer 170, of interconnected neurons. The weighted sums for layer 1, layer 2 and output layer can be computed similarly.

As shown above, in each layer, the weighted sum has to be computed for each node. The vector size of the input layer, hidden layer and output layer could be very large (e.g. 256). Therefore, the computations involved may become very extensive. In order to support the needed heavy computations efficiently, specialized hardware has been developed.

In FIG. 2A, a building block, MAC 210 comprising a multiplier 211 and an accumulator 212 is used to form a processing element 220. Various terminals or pins associated with each MAC 210 are label as weight 213, activation value 214, partial sum from a previous stage 215, and updated partial sum 216. For an input layer, an input value is provided to terminal 214. In FIG. 2B, it illustrates an example of processing element (PE) 220 comprising N MAC's.

FIG. 3 illustrates a device 300 comprising M PE's (330-1, 330-2, . . . , 330-M) for computing weighted sums for a neural network with M input (X₁ . . . X_{M}) and N neurons in the hidden layer, where the PE as shown in FIG. 2B can be used as the M PE's (330-1, 330-2, . . . , 330-M). The weighted sums (Y₁ . . . Y_{N}) for the N neurons are computed according to (3):

Yⱼ=Σᵢ₌₁^{M}WᵢⱼXᵢ, for j=1, . . . ,N. (3)

For input layer, the activation vector 310 corresponds to the input vector (X₁ . . . X_{M}). The inputs are loaded into registers (320-1, 320-2, and 320-M). The M PEs operate in a systolic fashion, where all PEs perform same operations according to system clocks. In particular, at one system clock, the multiplication (211) is performed at each multiplier (211) of the PE 200. At the next system clock, the multiplication result from each multiplier (211) is added to a partial sum from a previous PE using adder (212). The adder is often referred as accumulator. In this disclosure, the term adder and accumulator are used interchangeably. As shown in FIG. 3, the device is initialized by resetting all internal registers. The input X₁ becomes available for the operations of PE 1 (330-1) during the first clock cycle. The partial sum inputs for PE 1 (330-1) are all zero. At the first cycle, the outputs from the N MACs (210) correspond to W₁₁ X₁, W₁₂ X₁, . . . , W_{1N} X₁. During the second clock cycle, the multipliers of PE 2 (330-2) generate multiplication results W₂₁ X₂, W₂₂ X₂, . . . , W_{2N} X₂. The adders in PE 2 (330-2) add the multiplication results W₂₁ X₂, W₂₂ X₂, . . . , W_{2N} X₂ with corresponding partial sums from PE 1 (330-1) to generate updated partial sums W₁₁ X₁+W₂₁ X₂, W₁₂ X₁+W₂₂ X₂, . . . , W_{1N} X+W_{2N} X₂. The partial sums continue to be updated at each clock cycle until the last stage (i.e., PE M). The first partial sum output from the first MAC of PE M (330-M) becomes: W₁₁ X₁+W₂₁ X₂,+, . . . , +W_{1M} X_{M}=Y₁. Similarly, the last partial sum output from the last MAC of PE M (330-M) becomes: W_{1N} X₁+W_{2N} X₂,+, . . . , +W_{MN} X₁=Y_{N}. Accordingly, it takes M clock cycles for the array of PEs to generate the weighted sums. When the number of the inputs is large, it will take long time to generate the weighted sum. For example, if M is equal to 256, it will take 256 clock cycles to calculate a weighted sum. In some systems, there may be many layers for the neural networks. The time required to compute the weighted sums for all layers becomes substantially large.

The device in FIG. 3 only shows some key components for computing the weighted sum using an array of PEs. As is understood in the field, the device also includes timing and control circuitry (not shown in FIG. 3) to properly coordinate the systolic operations. The device may also include buffers to store inputs, outputs, intermediate results, weights or a combination of them.

As mentioned above, the conventional PEs will take a long time to generate the weighted sums when the number of inputs is large. It is desirable to develop a device that can reduce the time required to compute the weighted sums.

### SUMMARY OF INVENTION

A computing device for fast weighted sum calculation in neural networks is disclosed, where the neural networks have M inputs and N output, and M and N are integer greater than 1. The computing device comprises N processing elements with each processing element designated for calculating a weighted sum for one target output. Each processing element comprises M multipliers and a plurality of adders arranged to add the M weighted inputs to generate said one target output. The M multipliers are coupled to M inputs and M weights respectively.

In one embodiment, M corresponds to a power-of-2 integer and the plurality of adders corresponds to (M−1) adders arranged in a binary-tree fashion to add the M weighted inputs to generate said one target output.

In another embodiment, each processing element further comprises timing and control circuitry to coordinate systolic operations for the M multipliers and the plurality of adders. Each processing element may further comprise a buffer to store the M weights. Alternatively, the M weights are provided to each processing element externally.

A method for fast weighted sum calculation in neural networks is also disclosed, where the neural networks have M inputs and N output, and M and N are integer greater than 1. The method comprises utilizing N processing elements to calculate weighted sums for the N outputs by utilizing one processing element designated for calculating a weighted sum for one target output. Furthermore, said utilizing said one processing element designated for calculating a weighted sum for one target output comprises: multiplying M inputs and M weights respectively using M multipliers in said one processing element to generate M weighted inputs for said one target output, wherein the M weights are associated with said one target output; adding the M weighted inputs to generate said one target output using a plurality of adders in said one processing element; and providing said one target output.

In one embodiment of the method, M corresponds to a power-of-2 integer and the plurality of adders corresponds to (M−1) adders arranged in a binary-tree fashion to add the M weighted inputs to generate said one target output.

In another embodiment, each processing element further comprises timing and control circuitry to coordinate systolic operations for the M multipliers and the plurality of adders. Furthermore, each processing element further comprises a buffer to store the M weights. Alternatively, the M weights are provided to each processing element externally.

### BRIEF DESCRIPTION OF THE DRAWINGS

FIG. 1A illustrates an example of neural network with an input layer, a hidden layer and an output layer.

FIG. 1B illustrates an example of neural network with an input layer, two internal layers and an output layer.

FIG. 2A illustrates a building block, MAC comprising a multiplier and an accumulator used to form a processing element.

FIG. 2B illustrates an example of a generic processing element (PE) according to the conventional architecture that can be used to compute the weighted sum for the neural networks.

FIG. 3 illustrates an example of a configuration based on conventional processing element (PE) to compute the weighted sum for the neural networks.

FIG. 4 illustrates an example of a rotated processing element (PE) according to the present invention that can be used to quickly compute the weighted sum for the neural networks.

FIG. 5 illustrates an example of a configuration based on processing element (PE) of the present invention to quickly compute the weighted sum for the neural networks.

FIG. 6A illustrates an example of a neural network with 8 inputs and 4 output, where the weighted sums are to be computed using an array of processing elements according to the present invention.

FIG. 6B illustrates an example of a configuration using 4 processing elements with 8 inputs each according to the present invention to calculate the weighted sum for the neural network in FIG. 6A.

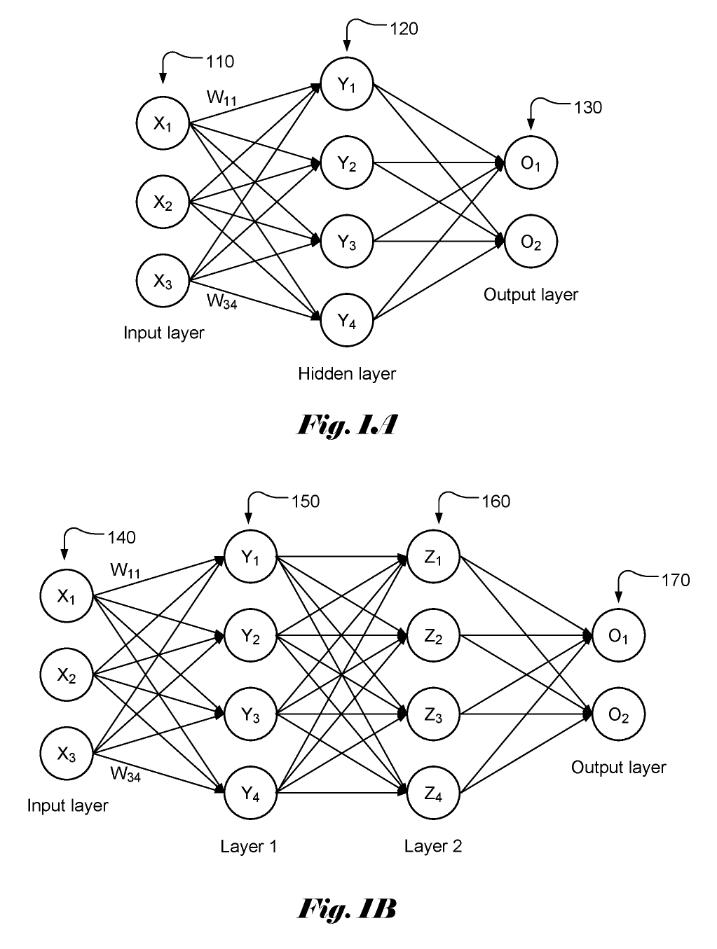

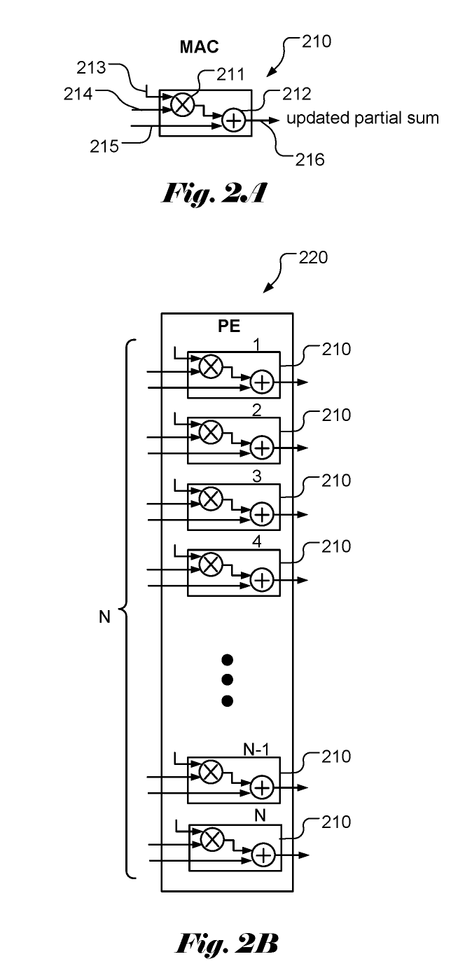

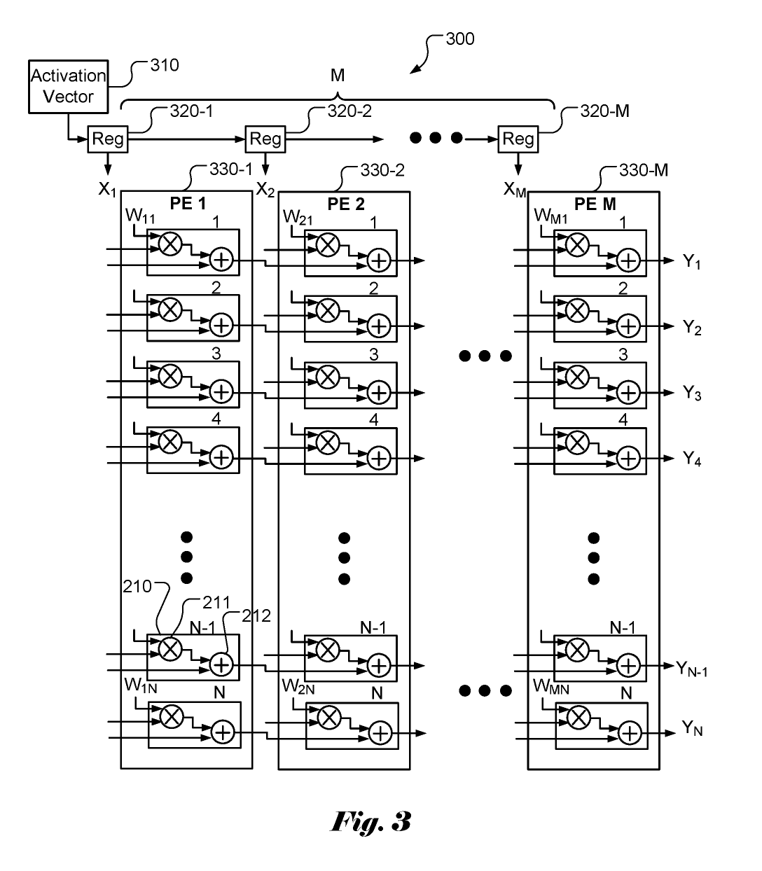

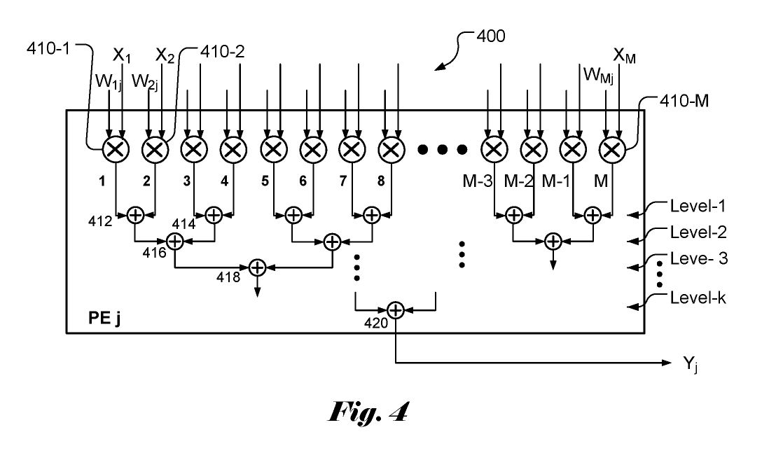

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the description like reference numbers appearing in the drawings and description designate corresponding or like elements among the different views.

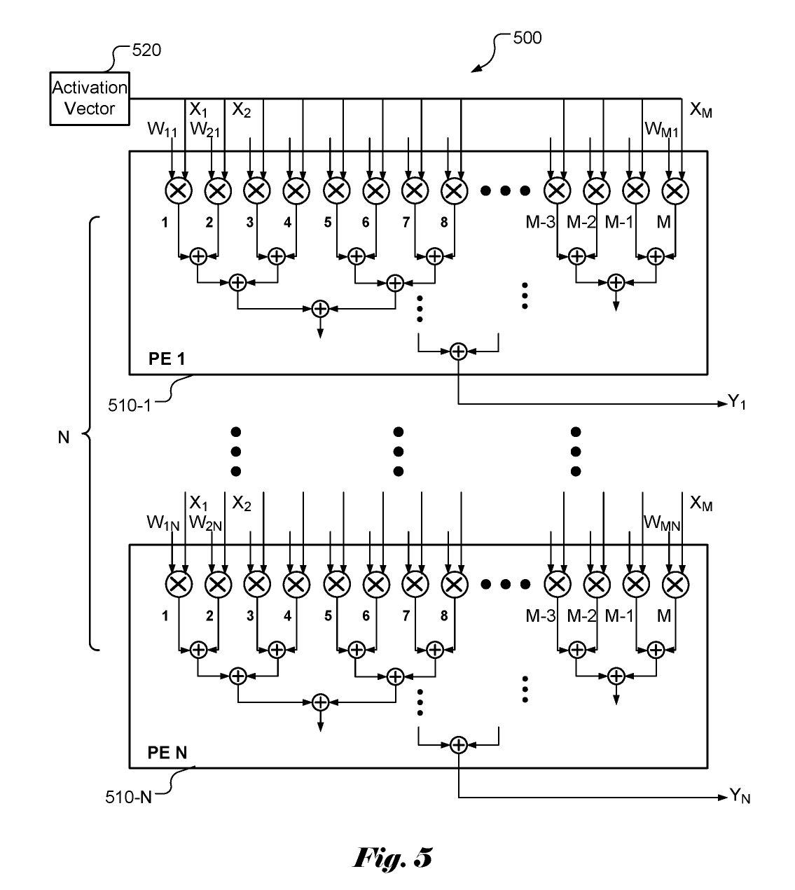

As mentioned above, the weighted sum calculation plays an important role in neural networks and deep learning. The conventional devices in the market usually is configured as an array of processing elements (PEs), where the output (i.e., the partial sum) of one PE is fed to the input of the next stage for more weighted sums. In particular, a popular configuration being used designates each PE to one input. For example, for M inputs (X₁, X₂, . . . , X_{M}) as shown in FIG. 3, PE 1 (330-1) is designated for input X₁, PE 2 (330-2) is designated for input X₂, and so on. As mentioned previously, it will require M clock cycles to compute all weighted sums for all outputs (Y₁, Y₂, . . . , Y_{N}). If the size (i.e., M) of the input vector is large, it will take a long time to complete the weighted sum calculation. It will get worse when the input vector size gets larger. Accordingly, the present invention discloses a processing element (PE) architecture that is configured to add weighted inputs within the PE. Furthermore, the input vector or activation vector is broadcast to all PEs so that each PE receives all inputs at the same time. FIG. 4 illustrates an example of PE 400 according to an embodiment of the present invention. The PE comprises M multipliers (410-1, 410-2, . . . , 410-M). One input and one associated weight are provided to each multiplier. The multipliers are paired so that two neighboring weighted inputs are added by a level-1 adder. For example, the output (i.e., W₁ⱼX₁) of multiplier 410-1 and output i.e., W₂ⱼX₂) of multiplier 410-2 are added by adder 412. The output of adder 412 corresponds to (W₁ⱼX₁+W₂ⱼX₂). The outputs of two neighboring adders are added by a next level adder. Therefore, outputs from adder 412 and 414 in level 1 are added by a level-2 adder 416. Therefore, the output of level-2 adder 416 corresponds to (W₁ⱼX₁+W₂ⱼX₂+W₃ⱼX₃+W₄ⱼX₄) and the output of level-3 adder 418 corresponds to (W₁ⱼX₁+W₂ⱼX₂+W₃ⱼX₃+W₄ⱼX₄+W₅ⱼX₅+W₆ⱼX₆+W₇ⱼX₇+W₈ⱼX₈). If M is chosen to be power of 2, the total number of adder levels is log₂M. In other words, the last level k is equal to log₂M. The output from adder 420 is (WᵢⱼX₁+W₂ⱼX₂+ . . . +W_{Mj}X_{M})=Yⱼ. In other words, each PE can be configured to calculate the weighted sum for a target output, Yⱼ.

In FIG. 4, the M multipliers can operate concurrently. In other words, in one clock cycle, the M multiplications can be executed. The M weighted inputs are added pair-wise by the M/2 level-2 adders. Again, the level-1 additions can be executed in one clock cycle. After one clock cycle for multiplication and k (i.e., log₂M) clock cycles for additions, a target output, Yⱼ can be calculated. If M is equal to 256, the weighted sum for target output, Yⱼ can be calculated in 9 clock cycles (i.e., 1 for multiplication and 8 for additions). On the other hand, the conventional approach will need 1 clock cycle for multiplication and 256 clock cycles for additions to calculate the weight sum. Accordingly, the speed according to the present invention is about 32 times as fast as the conventional approach. The speed improvement is larger for larger input or activation size. When M is large, the speed improvement is about (M/log₂M).

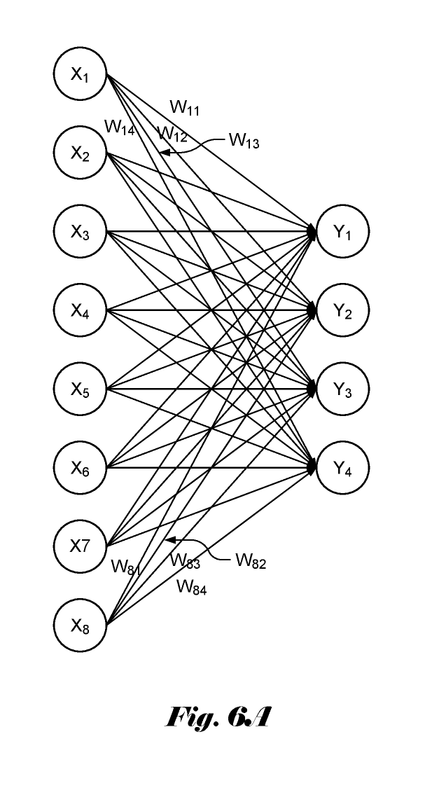

To support the weighted sum calculation associated with (X₁, X₂, . . . , X_{M}) and (Y₁, Y₂, . . . , Y_{N}), an exemplary architecture based on the present invention is shown in FIG. 5. The device 500 according to the present invention comprises N PEs (510-1, . . . , 510-N), where each PE comprises M multipliers and (log₂M) levels of adders as shown in FIG. 4. The activation vector 520 (i.e., the inputs (X₁, X₂, . . . , X_{M}) in this case) is broadcast to all PEs so that inputs (X₁, X₂, . . . , X_{M}) are provided to the input ports of all PEs. The weights required for calculating the weighted sums are also provided to corresponding input ports of the PEs. According to an embodiment of the present invention, each PE is configured to calculate the weighted sum for one output Yⱼ. For example, the weights provided to PE 1 correspond to (W₁₁, W₂₁, . . . , W_{M1}) for calculating weighted sum for Y and the weights provided to PE N correspond to (W_{1N}, W_{2N}, . . . , W_{MN}) for calculating weighted sum for Y_{N}. The weights can be stored in one or more weights buffers, which can be either on chip (i.e., on the same chip of the PEs) or off chip.

As a comparison, for the architecture of conventional PE array in FIG. 3, M PEs are used for calculating weighted sums for M inputs and N outputs, where each PE comprises N MACs (multiplier-accumulator). The partial weighted sums associated with all outputs (i.e., (Y₁, Y₂, . . . , Y_{N})) from one PE propagate to the next PE. The final weighted sums for all outputs are obtained from the outputs of the last stage PE (i.e., PE M in FIG. 3). On the other hand, the present invention uses a “rotated” architecture, where N PEs are used for calculating weighted sums for M inputs and N outputs and each PE comprises M multipliers and multiple-level accumulators. Furthermore, the weighted sum for a target output can be quickly calculated by one designated PE. When M is chosen to be a power of 2 number, the total number of accumulators is equal to (M/2+M/4, + . . . +1), which is equal to (M−1). The total number of multipliers for the PE array of the present invention is M×N and the total number of accumulators for the PE array of the present invention is (M−1)×N. On the other hand, the total number of multipliers for the conventional approach is M×N and the total number of accumulators for the conventional approach is also M×N. However, the first layer of accumulators in PE 1 may be deleted, so the total number of accumulators is (M−1)×N. Therefore, the architecture according to the present invention does not increase the hardware complexity. However, since the whole input vector or the activation vector is broadcast to all PEs, the traces on the chip are expected to take slightly more routing areas. Nevertheless, the speed benefits provided by the present invention outweigh the small chip area increase.

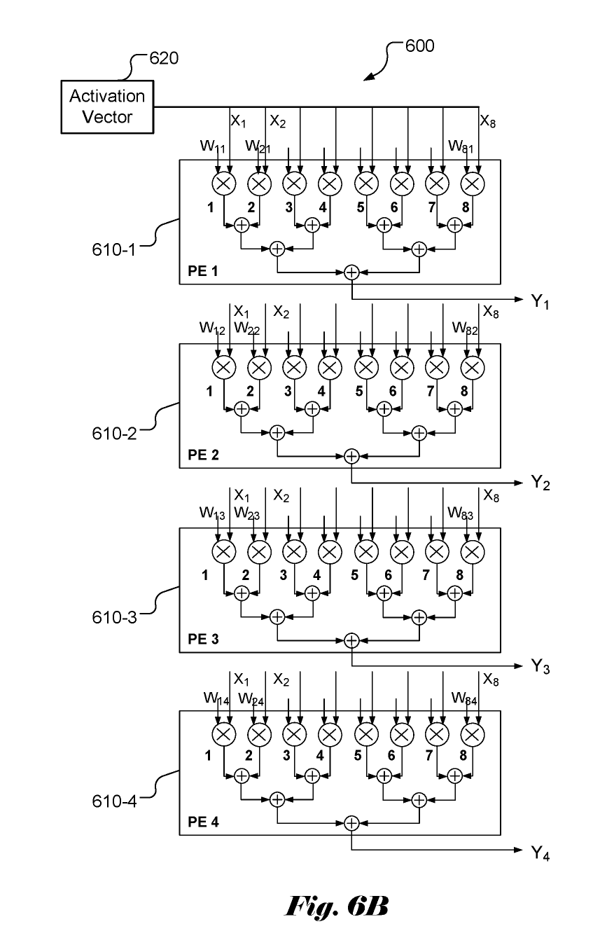

In FIGS. 6A and 6B, an example of weighted sums calculation for a layer with 8 (i.e., M) inputs and 4 (i.e., N) outputs are demonstrated based on the architecture of the present invention. In FIG. 6A, the weights Wᵢⱼ associated with the inputs and outputs are indicated. In FIG. 6B, the device 600 comprises 4 PEs (610-1, 610-2, 610-3 and 610-4) to compute the weighted sums for the 4 outputs (Y₁, Y₂, Y₃, Y₄). For the 8 inputs, each PE comprises 8 multipliers and 7 (i.e., M−1) accumulators to perform weighted sum calculation. The weights provided to the 4 PEs are (W₁₁, W₂₁, W₃₁, W₄₁, W₅₁, W₆₁, W₇₁, W₈₁), (W₁₂, W₂₂, W₃₂, W₄₂, W₅₂, W₆₂, W₇₂, W₈₂), (W₁₃, W₂₃, W₃₃, W₄₃, W₅₃, W₆₃, W₇₃, W₈₃) and (W₁₄, W₂₄, W₃₄, W₄₄, W₅₄, W₆₄, W₇₄, W₈₄). The weighted sums for the 4 outputs can be calculated in 4 clock cycles (1 clock cycle for multiplication and 3 clock cycles for the addition).

The above description is presented to enable a person of ordinary skill in the art to practice the present invention as provided in the context of a particular application and its requirement. The invention may be embodied in other specific forms without departing from its spirit or essential characteristics. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Various implementations of the systems and techniques described here can be realized in digital electronic circuitry, integrated circuitry, specially designed ASICs (application specific integrated circuits), field programmable gate array (FPGA), and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. The software code or firmware codes may be developed in different programming languages and different format or style. The software code may also be compiled for different target platform. However, different code formats, styles and languages of software codes and other means of configuring code to perform the tasks in accordance with the invention will not depart from the spirit and scope of the invention.

1. A computing device for fast weighted sum calculation in neural networks having M inputs and N output, wherein M and N are integer greater than 1, the computing device comprising:
N processing elements with each processing element designated for calculating a weighted sum for one target output, wherein the N processing elements generate all N weighted sums in one multiplication clock cycle plus a plurality of addition clock cycles and each processing element comprises:
M multipliers coupled to M inputs and M weights respectively, wherein the M weights are associated with the M inputs and said one target output, and wherein each of the M multiplier performs multiplication of one input with one weight to generate one weighted input, and the M multipliers generate M weighted inputs; and
a plurality of adders arranged to add the M weighted inputs to generate said one target output.

2. The computing device of claim 1, wherein M corresponds to a power-of-2 integer and the plurality of adders corresponds to (M−1) adders arranged in a binary-tree fashion to add the M weighted inputs to generate said one target output.

3. The computing device of claim 1, wherein each processing element further comprises timing and control circuitry to coordinate systolic operations for the M multipliers and the plurality of adders.

4. The computing device of claim 1, wherein each processing element further comprises a buffer to store the M weights.

5. The computing device of claim 1, wherein the M weights are provided to each processing element externally.

6. A method for fast weighted sum calculation in neural networks having M inputs and N output, wherein M and N are integer greater than 1, the method comprising:
utilizing N processing elements to calculate weighted sums for the all N outputs in one multiplication clock cycle plus a plurality of addition clock cycles and, wherein said utilizing the N processing elements comprises:
utilizing one processing element designated for calculating a weighted sum for one target output, wherein said utilizing said one processing element designated for calculating a weighted sum for one target output comprises:
multiplying M inputs and M weights respectively using M multipliers in said one processing element to generate M weighted inputs for said one target output, wherein the M weights are associated with the M inputs and said one target output;
adding the M weighted inputs to generate said one target output using a plurality of adders in said one processing element; and
providing said one target output.

7. The method of claim 6, wherein M corresponds to a power-of-2 integer and the plurality of adders corresponds to (M−1) adders arranged in a binary-tree fashion to add the M weighted inputs to generate said one target output.

8. The method of claim 6, wherein each processing element further comprises timing and control circuitry to coordinate systolic operations for the M multipliers and the plurality of adders.

9. The method of claim 6, wherein each processing element further comprises a buffer to store the M weights.

10. The method of claim 6, wherein the M weights are provided to each processing element externally.
